(19) United States
(12) Patent Application Publication
(10) Pub. No.: US 2022/0099459 A1
(43) Pub. Date: Mar. 31, 2022

(54) MAP DATA GENERATION SYSTEM, DATA CENTER, AND IN-VEHICLE APPARATUS

(71) Applicant: DENSO CORPORATION, Kariya-city (JP)

(72) Inventor: Hirohisa WATANABE, Kariya-city (JP)

(21) Appl. No.: 17/547,619

(22) Filed: Dec. 10, 2021

Related U.S. Application Data
(63) Continuation of application No. PCT/JP2020/021386, filed on May 29, 2020.

(30) Foreign Application Priority Data
Jun. 13, 2019 (JP) 2019-110336

(51) Int. Cl. G01C 21/00; G01C 21/34; B60W 60/00; H04W 4/40

(52) U.S. Cl. CPC G01C 21/3841; G01C 21/3881; G01C 21/3415; B60W 2556/50; H04W 4/40; B60W 2556/40; B60W 60/001

(57) ABSTRACT

A map data generation system includes: in-vehicle apparatuses respectively provided in vehicles: and a data center communicably connected with the in-vehicle apparatuses. In the data center, probe data are collected from the in-vehicle apparatuses for performing a road map data generating and updating process of generating and updating a road map data. A shortage road unit is determined to be one of data management units corresponding to road sections, road links, or meshes into which a map is divided, and have a shortage in a required number of probe data to perform the road map data generating and updating process. A notification indicating the shortage road unit is issued to the in-vehicle apparatuses. In the in-vehicle apparatus, a guidance for the vehicle to travel on the shortage road unit is provided in response to receiving the notification from the data center.

### CROSS REFERENCE TO RELATED APPLICATIONS

The present application is a continuation application of International Patent Application No. PCT/JP2020/021386 filed on May 29, 2020, which designated the U.S. and claims the benefit of priority from Japanese Patent Application No. 2019-110336 filed on Jun. 13, 2019. The entire disclosures of all of the above applications are incorporated herein by reference.

### TECHNICAL FIELD

The present disclosure relates to a map data generation system, a data center, and an in-vehicle apparatus that generate and update a map data based on probe data collected from a plurality of vehicles.

### BACKGROUND

For example, as a technology for generating a digital road map used for a car navigation apparatus or automatic driving control, a system that generates/updates a map data based on probe data collected from a plurality of probe cars can be considered. In this system, a plurality of vehicles, which are probe cars, are communicably connected to the center, and the center collects, as probe data, vehicle traveling position data obtained over time from GPS as each vehicle travels. Then, the center reproduces the traveling locus of each road from the probe data and updates the map data based on the difference detected from the basic map data in the database.

### SUMMARY

According to an example of the present disclosure, a map data generation system is provided to include: in-vehicle apparatuses respectively provided in vehicles; and a data center communicably connected with the in-vehicle apparatuses. In the data center, probe data are collected from the in-vehicle apparatuses for performing a road map data generating and updating process of generating and updating a road map data. A shortage road unit is determined to be one of data management units corresponding to road sections, road links, or meshes into which a map is divided, and have a shortage in a required number of probe data to perform the road map data generating and updating process. A notification indicating the shortage road unit is issued to the in-vehicle apparatuses. In the in-vehicle apparatus, a guidance for the vehicle to travel on the shortage road unit is provided in response to receiving the notification from the data center.

### BRIEF DESCRIPTION OF DRAWINGS

The objects, features, and advantages of the present disclosure will become more apparent from the following detailed description made with reference to the accompanying drawings. In the drawings:

FIG. 1 is a block diagram schematically showing an overall configuration of a map generation system according to a first embodiment;

FIG. 2 is a flowchart schematically showing steps of processing executed by an in-vehicle apparatus;

FIG. 3 is a block diagram schematically showing an overall configuration of a map generation system according to a second embodiment;

FIG. 4 is a flowchart illustrating steps of processing executed by a server in a data center;

FIG. 5 is a flowchart schematically showing steps of processing executed by an in-vehicle apparatus; and

FIG. 6 is a diagram illustrating an example of meshes, which a map is divided into, as data management units according to another embodiment.

### DETAILED DESCRIPTION

### (1) First Embodiment

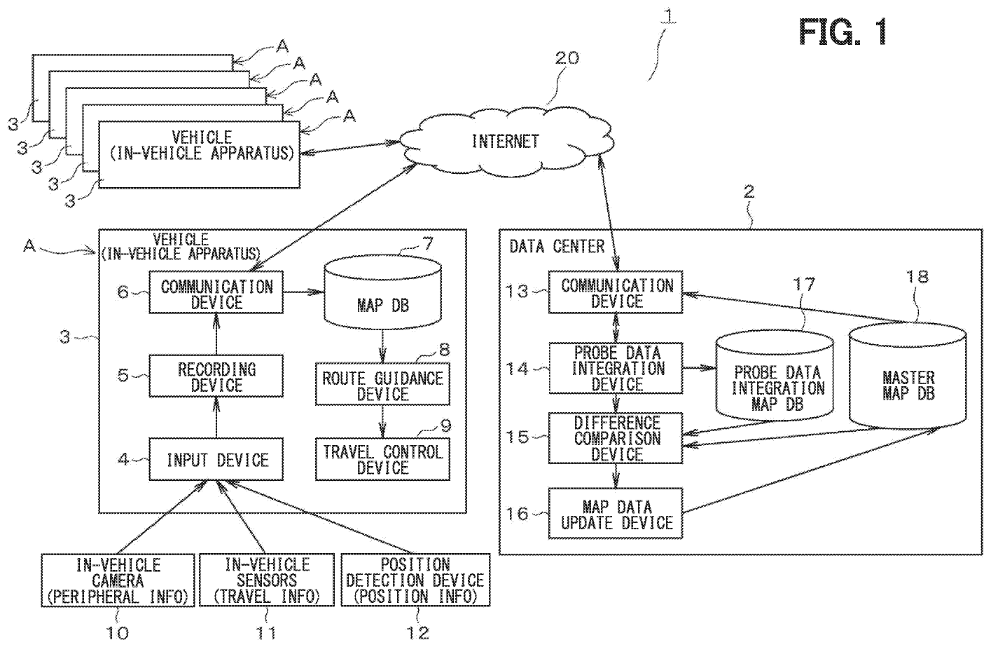

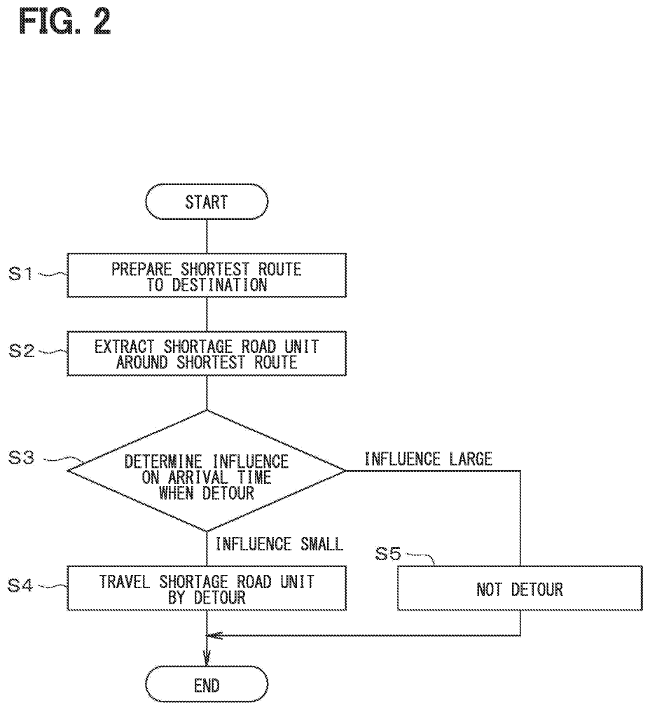

Hereinafter, a first embodiment will be described with reference to FIGS. 1 and 2. FIG. 1 schematically shows the overall configuration of a map generation system 1 according to the present embodiment. Here, the map generation system 1 is configured by communicably connecting the data center 2 and a vehicle group A including a plurality of vehicles A traveling on the roads. Specifically, the vehicle group

A include a whole of general automobiles such as a passenger car and a truck. The data center 2 collects probe data from a large number of vehicles A and generates 1 updates a road map data.

Each vehicle A is equipped with an in-vehicle apparatus 3 for realizing the road map generation system 1. The in-vehicle apparatus 3 mainly includes a computer, and includes an input operation device, a display device, peripheral devices such as an audio output device, a wireless communication device, and the like. Using the hardware configuration and the software configuration, the in-vehicle apparatus 3 includes an input device 4 for inputting various information to be probe data, a recording device 5 for recording the input data, a communication device 6, a map database 7, a route guidance device 8 as a navigation device, and a travel control device 9. Note that the input device 4, the recording device 5, the route guidance device 8, and the travel control device 9 may be included in a controller included in the computer in the in-vehicle apparatus 3.

The input device 4 is connected with the in-vehicle camera 10, The input device 4 receives camera image information, that is, peripheral information taken by the in-vehicle camera 10 while the vehicle A is traveling. A wide-angle camera is adopted as the in-vehicle camera 10, and is provided, for example, on the front and rear and left and right of the vehicle A. The in-vehicle camera 10 may have a function at least to capture an image of the front of the vehicle A. Further, traveling information from various in-vehicle sensors 11 is input to the input device 4. The various in-vehicle sensors 11 include a speed sensor that detects the speed of the host vehicle, and a direction sensor that detects the traveling direction, that is, the direction of the host vehicle.

Further, the vehicle position information from the position detection device 12 is input to the input device 4. The position detection device 12 detects the position of the host vehicle based on the reception data of a well-known GPS receiver and the like. In this way, the camera image information on the surroundings of the vehicle A, the traveling information on the vehicle A, and the position information on the vehicle A when the vehicle A is traveling are input to the input device 4. Such information is recorded in the recording device 5 as probe data together with date and time data. In the case of a road having a plurality of lanes, that is, travel lanes, the probe data also includes data on which lane the vehicle A has traveled.

The communication device 6, which may also be referred to as a wireless transceiver 6, communicates with the data center 2 via a mobile communication network, the Internet 20, or the like. In this case, the probe data recorded in the recording device 5 is transmitted to the data center 2 by the communication device 6 periodically, for example, once a day. Further, the map database 7 stores, for example, road map information nationwide. In this case, the latest map data is distributed and updated from the data center 2 to the map database 7 via the communication device 6.

The route guidance device 8 realizes a well-known location function and route guidance function as a navigation device. Among them, the location function displays the detected position of the host vehicle A together with the road map on the screen of a display device such as a center display provided on the instrument panel. The route guidance function searches for a recommended route to a destination specified by the user, and presents the route by the screen display of the display device or the guidance speech. The travel control device 9 uses the road map data stored in the map database 7 to perform a vehicle control of in-vehicle actuators such as an accelerator, a brake, and a steering wheel to realize automatic driving, autonomous driving, the like.

In contrast, the data center 2 includes a server computer and its peripheral apparatuses, a large-capacity storage device, a wireless communication device, and the like. With such hardware configuration and software configuration, the data center 2 includes a communication device 13, a probe data integration device 14, a difference comparison device 15, and a map data update device 16 while including a probe data integrated map database 17 and a master map database 18. In this case, a high-precision basic map data that can be used for an automatic driving control of the vehicle A is generated and stored in the master map database 18. Then, the high-precision basic map data stored in the master map database 18 is also distributed to each vehicle

A; the equivalent data is stored in the map database 7 in the in-vehicle apparatus 3 in the vehicle A. Note that, the probe data integration device 14, the difference comparison device 15, and the map data update device 16 may be included in a controller included in the sever computer in the data center 2.

The communication device 13, which may also referred to as a transceiver 13, performs data communication with the in-vehicle apparatus 3 in each vehicle A via the Internet 20 or the like, and receives probe data transmitted from a large number of in-vehicle apparatuses 3. Therefore, the communication device 13 realizes the function as the probe data collection device. hi this case, probe data are collected from, for example, general vehicles A traveling all over Japan. It is predicted that there will be millions of vehicles A capable of acquiring and transmitting probe data in the future, and a huge amount of probe data will be collected from these vehicles A.

The probe data integration device 14 integrates a large number of probe data collected via the communication device 13 to generate an integrated map data. The generated integrated map data is written in the probe data integrated map database 17. In this case, as will be described in detail later, the probe data integration device 14 is configured to generate an integrated map data when a required number of probe data is collected for each road section or road link as a data management unit. The required number may be fixed to a predetermined number, for example, 10. However, it can be set for each road type, for example, 10 for national expressways and 12 for general national highways.

The difference comparison device 15 compares the integrated map data integrated by the probe data integration device 14 with the basic map data stored in the master map database 18 to obtain a difference. Then, the difference may be obtained by the difference comparison device 15; namely, a change in the shape of the road, an increase or decrease in the number of lanes, or the like is confirmed. In this case, the map data update device 16 thereby updates the basic map data stored in the master map database 18. Further, when the basic map data is updated, the communication device 13 transmits the latest updated map data to the in-vehicle apparatus 3 in each vehicle A.

In this case, as described later in the explanation of the action, in the present embodiment, the probe data integration device 14 not only performs the integration process of integrating the probe data, but also determines the road section or road link as a data management unit that is insufficient in the number of probe data required for a road map data generating and updating process of generating/updating map data. Therefore, the probe data integration device 14 has a function as a data shortage determination device. For example, suppose a case where for a road section or road link, the collected probe data have not reached 10 (ten) as a require number of probe data even when one month elapses since the road map data generating and updating process was previously performed. In such a case, the road section or road link is determined to be a shortage road unit which has a shortage in the required number of probe data. In the case of a road having a plurality of lanes, a shortage is determined for each lane. The data of this shortage road unit is also written in the probe data integrated map database 17.

Then, when the probe data integration device 14 generates the data of the shortage road unit, the communication device 13 notifies the in-vehicle apparatus 3 of each vehicle A of the data of the shortage road unit. Therefore, the communication device 13 has a function as a notification device. As described above, the data of the shortage road unit is written in the probe data integrated map database 17. However, after that, when more probe data than necessary is collected and the shortage state is resolved, the corresponding road section or road link is deleted from the data of the shortage road unit. In addition, the data of the shortage road unit notified to each in-vehicle apparatus 3 also includes data to the effect that the corresponding road section or road link in which the shortage state has been resolved should be deleted from the data of the shortage road unit.

In the present embodiment, when the in-vehicle apparatus 3 receives the data of the shortage road unit from the data center 2 by the communication device 6, the data of the shortage road unit is stored in the map database 7. Then, the in-vehicle apparatus 3 has a function as a guidance device that recommends that the host vehicle A travels on the shortage road unit when the notification of the shortage road unit data is received. In the present embodiment, the route guidance device 8 as a navigation device functions as a guidance device.

More specifically, as described in the following explanation of action, in the in-vehicle apparatus 3, when the route guidance device 8 is caused to seek and guide the route to the destination, the route guidance device 8 executes the route guidance so that the route to the destination includes the shortage road unit. Further, in this case, it is determined whether the influence on the arrival time when guiding the route including the shortage road unit is small with respect to the recommended route to the destination obtained by the route guidance device 8. When it is determined that the influence is small, the guidance route is provided to include the shortage road unit. Here, the determination as to whether or not the influence is small is made as follows. For example, when the increase in the estimated arrival time to the destination due to passing through the shortage road unit is within 10%, the influence is determined to be small. When the increase exceeds 10%, the influence is determined to be large.

Next, the operation of the map data generation system 1 having the above configuration will be described with reference to FIG. 2. As described above, in the in-vehicle apparatus 3 in each vehicle A, probe data recording the traveling status of the host vehicle A is generated as the host vehicle A travels, and is transmitted to the data center 2 by the communication device 6. In the data center 2, when the probe data from the in-vehicle apparatus 3 in each vehicle A is received by the communication device 13, the probe data integration device 14 executes the integration process of integrating the probe data.

In this case, the probe data integration device 14 generates an integrated map data when a required number of probe data are collected for each road section or road link as a data management unit. Next, the difference comparison device 15 executes a comparison process of comparing the integrated map data and the basic map data to obtain the difference. As a result, when there is a difference, the map data update device 16 executes an update process of updating the basic map data. Here, the probe data integration device 14 determines a road section or road link for which the number of probe data required for generating/updating map data is insufficient as a shortage road unit.

Specifically, for a first road section or road link, 10 probe data may not be collected even one month after the previous integration process. In this case, the first road section or road link is determined to be a shortage road unit and the data of the shortage road unit is written in the probe data integrated map database 17. When it is determined that the first road section or road link is a shortage road unit, the data of the shortage road unit is notified to the in-vehicle apparatuses 3. Then, the in-vehicle apparatus 3 receives the notification of the data of the shortage road unit. In this case, the data of the shortage road unit is stored; the route guidance device 8 is caused to recommend the host vehicle A to travel on the shortage road unit. In this case, when a predetermined condition is satisfied, route guidance is executed so that the route to the destination includes the shortage road unit.

The flowchart of FIG. 2 schematically shows the steps of determining the route to the destination and processing the guidance executed by the route guidance device 8 in the in-vehicle apparatus 3 when the destination is set by the user. The method of setting the route to the destination is common to both the manual driving in which the user drives and the automatic driving. That is, first, in step S1, a recommended route from the current location to the destination is obtained. In this case, for example, a recommended route having the shortest mileage or shortest traveling time is obtained, and the standard required time to the destination when traveling on that route is calculated.

In step S2, the data of the shortage road unit in the map database 7 is searched around the obtained recommended route, for example, within I km, and the shortage road unit is extracted. In the next step 53, the time required to reach the destination along a detour route passing through the shortage road unit is compared with the time required to reach the destination along the recommended route, to determine whether the detour has a large influence on the arrival time. In this case, for example, when the increase in the estimated arrival time is within 10%, the influence is small: when it exceeds 10%, the influence is large.

Suppose it is determined in step S3 that the detour has little influence on the arrival time. In this case, in step S4, a detour route that passes through the shortage road unit is set, and route guidance or automatic driving is executed. When it is determined that the influence is large, in step S5, route guidance or automatic driving that passes through the recommended route without passing through the detour route is executed. Even if there are no shortage road unit around the recommended route, the recommended route will be guided as it is. Further, after the vehicle A travels, the probe data generated during the traveling is transmitted to the data center 2. Therefore, when traveling on a detour route, probe data including the shortage road unit will be transmitted.

As described above, according to the present embodiment, the following effects can be obtained. That is, if there is a road section or road link in which the number of probe data required for generating/updating map data is insufficient in the data center 2, the data of the shortage road unit is notified to the in-vehicle apparatuses 3. Then, in the in-vehicle apparatus 3, when the notification of the shortage road unit is received, it is recommended that the host vehicle A travels on the shortage road unit. As a result, even on a road where the number of traffic of the vehicles A tends to be small, the traveling of the vehicles A and the generation of probe data are promoted. Therefore, probe data is collected on a wide range of roads, and the coverage is improved.

As a result, according to the map data generation system 1 of the present embodiment, the map data is generated and updated based on the probe data collected from a plurality of vehicles A; the collection of probe data even for road sections or road links that are travelled relatively infrequently can be promoted. As a result, the data center 2 can always generate and update the latest and highly accurate map data. The latest and highly accurate map data can be distributed to the in-vehicle apparatuses 3.

In this case, in the present embodiment, the in-vehicle apparatus 3 is configured to include a route guidance device 8 as a navigation device, which executes route guidance or automatic driving so that the route to the destination includes a shortage road unit. As a result, in the vehicle A, the route guidance to the destination is provided so as to include the shortage road unit, so that the vehicle A can naturally travel on the shortage road unit, which is effective. In addition, it is possible to eliminate the need for a separate notification or dedicated device for guiding to a shortage road unit.

Especially in this embodiment, when it is determined that the influence on the arrival time when presenting the detour route including the shortage road unit is small with respect to the recommended route to the destination, the guidance route to the destination is configured to include the shortage road unit. As a result, it is possible to have the user of the vehicle A take a detour to the shortage road unit without overdoing it without imposing a great burden on the user. It goes without saying that various changes can be made to the criteria for determining whether or not the shortage road unit is in the vicinity of the recommended route and for determining whether the influence is small or large.

### (2) Second Embodiment

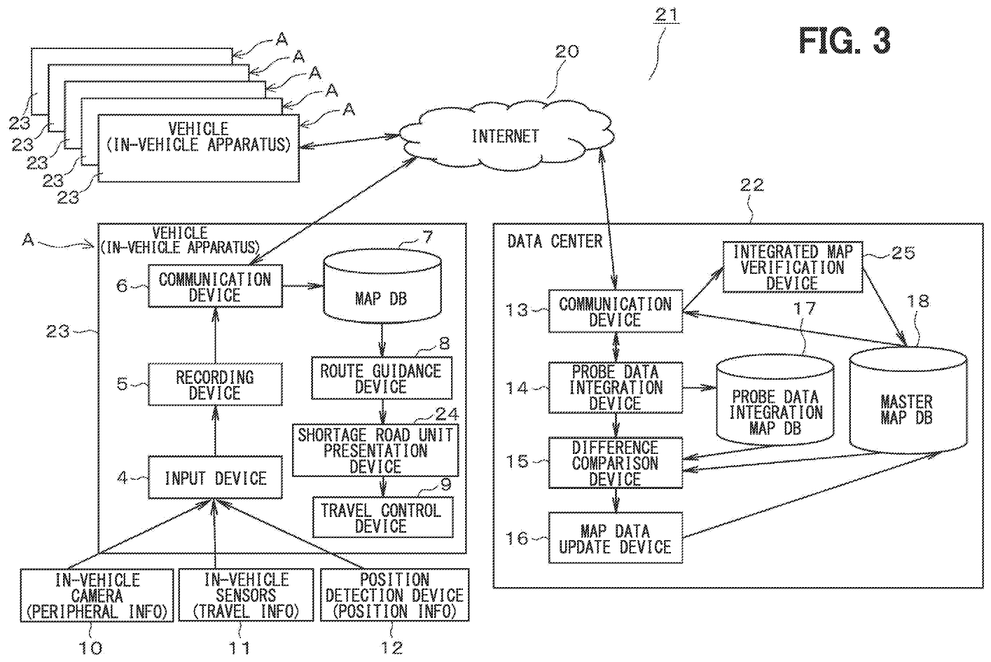

Next, a second embodiment will be described with reference to FIGS. 3 to 5. It should be noted that the same parts as those in the first embodiment are designated by the same reference signs, the repeated description will be omitted, and the points different from those in the first embodiment will be mainly described below. FIG. 3 schematically shows the overall configuration of the map generation system 21 according to the present embodiment.

Here, the map generation system 21 is configured by communicably connecting the data center 22 and a vehicle group A of a plurality of vehicles A traveling on the roads. Specifically, the vehicle group A include a whole of general automobiles such as a passenger car and a truck. Each vehicle A includes an in-vehicle apparatus 23 according to the present embodiment. The data center 22 collects probe data from a large number of in-vehicle apparatuses 23 in the vehicles A, and generates/updates a road map data.

Similar to the first embodiment, the in-vehicle apparatus 23 includes an input device 4, a recording device 5, a communication device 6, a map database 7, a route guidance device 8 as a navigation device, and a travel control device 9. Information from the in-vehicle camera 10, various in-vehicle sensors 11, and the position detection device 12 is input to the input device 4. Further, as will be described later, when the updated basic map data is delivered from the data center 22, the in-vehicle apparatus 23 is configured to execute the traveling in the shadow mode and returns the verification result to the data center 22.

In the present embodiment, the in-vehicle apparatus 23 is provided with a shortage road unit presentation device 24 for displaying information on the shortage road unit and urging the user to travel on the shortage road unit more positively. Note that, similar to the first embodiment, the input device 4, the recording device 5, the route guidance device 8, the travel control device 9, and the shortage road unit presentation device 24 may be included in a controller included in the computer in the in-vehicle apparatus 23.

When the in-vehicle apparatus 23 receives a notification about the shortage road unit from the data center 22, that is, when the in-vehicle apparatus 23 receives the probe instruction signal described later, the shortage road unit presentation device 24 displays the information on the shortage road unit to be traveled included in the probe instruction signal. The probe instruction signal is transmitted to the in-vehicle apparatus 23 in the vehicle A when the position of the shortage road unit exists within a circle having a predetermined distance, for example, a radius of 500 m or 1 km from the current position of the vehicle A or the planned travel route. The shortage road unit presentation device 24, together with the route guidance device 8, functions as a guidance device that recommends that the host vehicle A travel on the shortage road unit.

In this case, after notifying the in-vehicle apparatus 23 of the information on the shortage road unit by the probe instruction signal, the system administrator gives an incentive, that is, some privilege, to the user of the vehicle A who travels on the shortage road unit according to the guidance. In this case, the shortage road unit presentation device 24 is configured to display information on the shortage road unit together with incentive information. By giving the incentive in this way, it becomes a motivation for the user to cooperate in traveling on the shortage road unit by detouring, and it is possible to further promote traveling on the shortage road unit. Incentives in this case can be considered such as giving various points, discounting toll road tolls and parking lot tolls, discounting shopping in the service area, presenting souvenirs, discounting when purchasing vehicle-related equipment and fuel, giving priority to traveling in automatic driving.

On the other hand, similar to the above first embodiment, the data center 22 according to the present embodiment realizes the functions of the communication device 13, the probe data integration device 14, the difference comparison device 15, and the map data update device 16 as a notification device, while also including the probe data integrated map database 17 and the master map database 18. Then, in the present embodiment, the data center 22 includes an integrated map verification device 25 as a map verification device in addition to them. Note that, similar to the first embodiment, the probe data integration device 14, the difference comparison device 15, the map data update device 16, and the integrated map verification device 25 may be included in a controller included in the sever computer in the data center 22.

The integrated map verification device 25 has a function of verifying whether or not the basic map data is consistent with the actual road when the basic map data is updated based on the probe data. In the verification, each vehicle A is configured to run in the so-called shadow mode, and the verification result is returned from the in-vehicle apparatus 23 to the data center 22. When driving in shadow mode, both the updated new basic map data and the old basic map data are retained, For example, the actual driving is performed using the old basic map data, and it is evaluated whether or not the new basic map data is correct.

The integrated map verification device 25 performs, for example, an integration process of the verification results returned from each vehicle A, and determine whether to adopt it as formal basic map data. In this case, the integrated map verification device 25 adopts it as formal basic map data when the degree of deviation from the actual road is less than a predetermined threshold value. On the other hand, suppose a road section or road link as a data management unit for which the degree of deviation from the actual road is determined to be greater than or equal to the threshold value. Such a road section or road link is not adopted as the basic map data, but is determined preferentially as a shortage road unit lacking in probe data. Therefore, the integrated map verification device 25 has a function as a data shortage determination device.

The data center 22 transmits a probe instruction signal instructing each vehicle A to travel on the shortage road unit, by the communication device 13 to the in-vehicle apparatus 23 in each vehicle A. The probe instruction signal is transmitted to the in-vehicle apparatuses 23 in the case where the integrated map verification device 25 determines the shortage road unit in addition to the case where the probe data integration device 14 generates data on the shortage road unit. In the in-vehicle apparatus 23 that has received the probe instruction signal, not only when the route guidance to the destination is performed by the route guidance device 8, but also when any route guidance is not performed, the shortage road unit presentation device 24 displays information on the shortage road unit to the user, and encourages the user to travel on the shortage road unit.

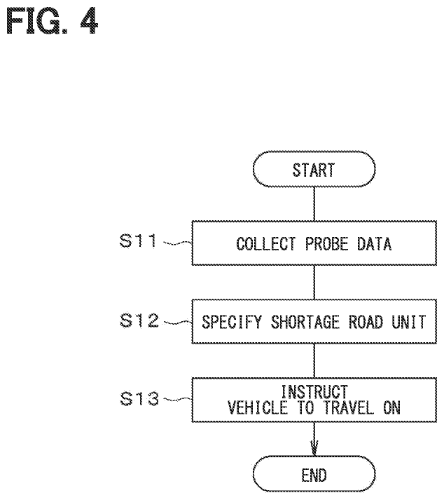

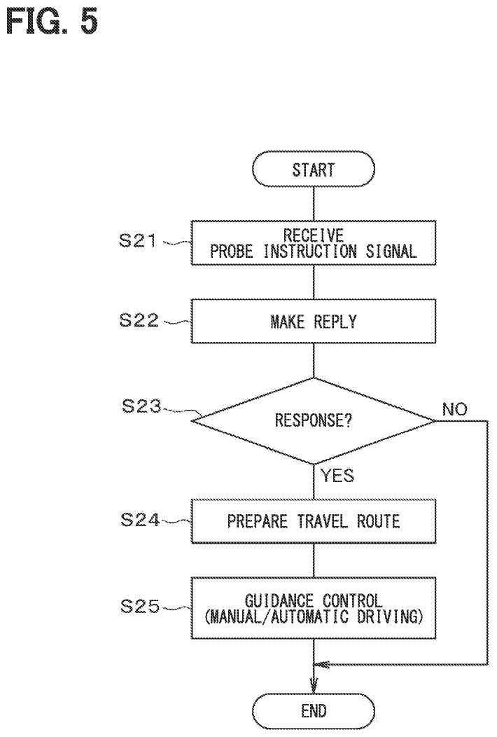

By the way, the flowchart of FIG. 4 schematically shows the steps of processing executed by the server in the data center 22. Further, the flowchart of FIG. 5 schematically shows the steps of processing executed when the in-vehicle apparatus 23 receives the probe instruction signal. In FIG. 4, first, in step 511, probe data is collected from a large number of in-vehicle apparatuses 23. In the next step S12, the shortage road unit is specified. Specifying the shortage road unit is made by the probe data integration device 14, which determines a road section or road link as a data management unit that lacks the number of probe data required to generate and update map data, and then by the integrated map verification device 25, which determines the shortage road unit, as described above.

When the shortage road unit is specified, in step S13, a probe instruction signal instructing the in-vehicle apparatus 23 in each vehicle A to travel on the specified shortage road unit is transmitted. Then the process is ended. In this case, the probe instruction signal may be transmitted to one or more specific in-vehicle apparatuses 23 that are traveling or scheduled to travel on the shortage road unit on the shortage road unit or near the shortage road unit within a predetermined distance. For example, the probe instruction signal may be transmitted only to the in-vehicle apparatus 23 in the vehicle A that exists at the position closest to the shortage road unit.

It is preferable that the information on the shortage road unit included in the probe instruction signal is represented by a link ID or a lane ID. The information on the shortage road unit may be configured so that the in-vehicle apparatus 23, which is the receiver, can identify which road should be passed. The specific expression form can be changed as appropriate, For example, the information on the shortage road unit may be represented by a sequence of coordinate points, or may be represented by a combination of a road name and an intersection name.

Next, in the flowchart of FIG. 5, the in-vehicle apparatus 23 receives the probe instruction signal from the data center 22 in step S21. Then, in step S22, a reply is made to the data center 22 as to whether or not it is possible to travel on the shortage road unit included in the probe instruction signal. This reply is made when the driver of the vehicle A, who sees the information on the shortage road unit displayed by the shortage road unit presentation device 24, operates the in-vehicle apparatus 23. Alternatively, the reply is made automatically when automatic driving is being executed. In step S23, it is determined whether or not the response is possible.

When it is possible to respond to the shortage road unit (Yes in step S23), a travel route passing through the shortage road unit is prepared in the next step S24. Then, in step S25, guidance control is performed so as to travel on the prepared travel route. Then the process is ended. In the case of manual driving, the guidance control in step S25 is performed by route guidance. In the case of automatic driving, in the in-vehicle apparatus 23, a control signal for autonomously traveling the travel route is output to the in-vehicle actuator, and automatic driving control is performed. This facilitates the collection of probe data for shortage road units. If it is not possible to travel on the shortage road unit (No in step S23), the process is ended as it is.

According to the map data generation system 21 of the second embodiment as described above, a map data is generated and updated based on the probe data collected from a plurality of vehicles A; the collection of probe data can be promoted even for road sections or road links that are travelled relatively infrequently. As a result, the data center 22 can always generate and update the latest and highly accurate map data, and can deliver the latest and highly accurate map data to the in-vehicle apparatuses 23.

In this case, particularly in the present embodiment the in-vehicle apparatus 23 is provided with a shortage road unit presentation device 24 for displaying information on the shortage road unit to be traveled included in the probe instruction signal. Therefore it is possible to further promote traveling on the shortage road unit. Further, in the present embodiment, the integrated map verification device 25 is provided in the data center 22. When the updated basic map data deviates significantly from the actual road with respect to a first road section or road link, the integrated map verification device 25 is configured to determine that the first road section or road link is a shortage road unit. This makes it possible to eliminate errors in the map data at an early stage when updating the basic map data.

### (3) Other embodiments

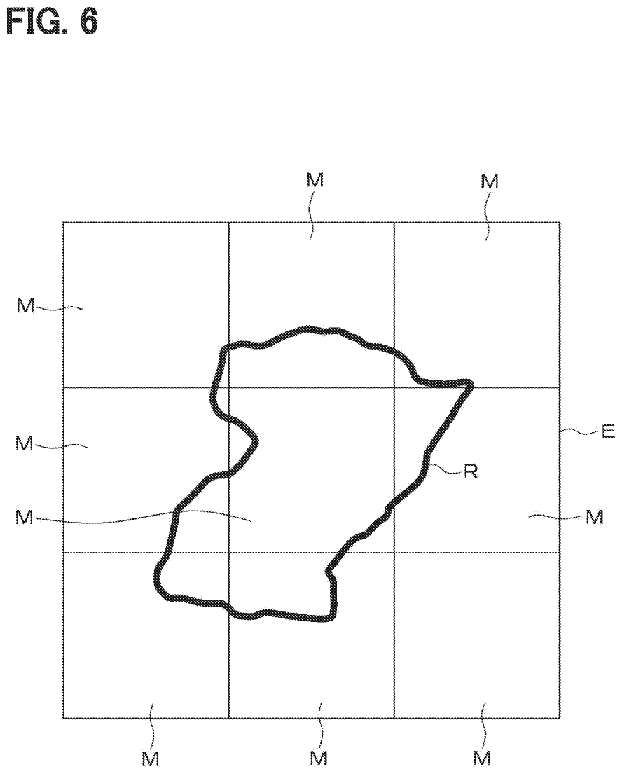

In each of the above embodiments, the wording “road section or road link” is used as a data management unit for probe data or map data. However, the data management unit also includes the concept of meshes into which a map is divided. Here, with reference to FIG. 6, meshes into which a map is divided as data management units will be described.

FIG. 6 shows an example of meshes M into which the area E of the map data is divided vertically and horizontally, that is, in the north-south direction and the east-west direction in a rectangular shape, and the area E includes a road R. Each mesh M can also be called a map tile, and corresponds to a map data of each of different areas. Each mesh M has, for example, a square shape of 2 km square. The size of the mesh M can be changed as appropriate, such as 1 km square, or 4 km square. Further, the shape of the mesh M may be a rectangle, a hexagon, a circle, or the like. Each mesh M may be set so as to partially overlap the adjacent mesh M. The size of the mesh M may be different for each layer or each road type.

Further, the size or shape of the mesh M may be non-uniform. For example, the mesh M in a rural area where the presence density of map elements such as landmarks is relatively sparse may be set larger than the mesh M in an urban area where the map elements are densely present. For example, the mesh M in the rural area may have a rectangular shape of 4 km square, while the mesh M in the urban area may have a rectangular shape of 1 km or 0.5 km square. The urban area here refers to, for example, an area where the population density is equal to or larger than a predetermined value or an area where offices and commercial facilities are concentrated. The rural area may be an area other than the urban areas.

In addition, the distribution mode of all map data may be defined by the data size. In other words, the map recording area may be divided and managed within a range defined by the data size. In that case, each mesh M is set so that the amount of data is less than a predetermined value based on the number or density of landmarks. According to such an aspect, the data size in one delivery can be set to a certain value or less. It is assumed that the real space range corresponding to the mesh M in the urban area is narrower than the real space range corresponding to the mesh M in the rural area. As mentioned above, it is expected that map elements such as landmarks or lane marks are more densely present in urban areas than in rural areas.

Further, each of the above embodiments can be modified and implemented as follows, for example. That is, in each of the above embodiments, the in-vehicle apparatuses 3 and 23 include the route guidance device 8 as a navigation device. However, regardless of the route guidance to the destination, it is possible to recommend traveling on the shortage road unit. It may be configured to propose to the user not only by displaying but also by speech to detour to the shortage road unit. This also makes it possible for the occupants of vehicle A to make a detour to the shortage road unit without overdoing it without imposing a great burden on the occupants.

Further, in the above-described embodiments, a general automobile as the vehicle A is configured to record and transmit probe data. However, commercial vehicles such as night buses or taxis can be applied, and can be configured to recommend running on shortage road units even in running of the night buses and patrolling of the taxis. In this case, in the running of the night buses and the patrolling of the taxis, relaxing the determination criteria for determining whether the above-mentioned shortage road units are around the recommended route or determining whether the influence is large may be considered according to the vehicle type or the statuses of vehicles.

In a data center, regardless of the number of data collected, when determining a shortage road unit, it is also possible to preferentially determine the road section or road link existing in a disaster area as a shortage road unit for which the probe data is insufficient. Here, in areas where there have been disasters such as earthquakes, tsunamis, floods, volcanic eruptions, fires, and major accidents, there may be changes in road shape due to roads or some lanes becoming impassable. Therefore, the road section or road link that has suffered such a disaster may be given priority to determining as a shortage road unit. This makes it possible to promote the subsequent collection of probe data and update the map data in response to changes in road statuses by disasters.

Then, in the data center, when determining the shortage road unit, the road section or road link where the automatic driving control of the vehicle A is interrupted or fails may be preferentially determined as se shortage road unit for which the probe data is insufficient. The road section or road link where the automatic driving is interrupted can be specified based on the probe data from the vehicles. When the in-vehicle apparatus interrupts the automatic driving for a reason other than overriding by the user, the in-vehicle apparatus uploads data including that fact to the data center together with the location information. In other words, when the in-vehicle apparatus executes the authority transfer process to the driver due to the system limit or MRM (Minimal Risk Maneuver), the in-vehicle apparatus uploads the fact to the data center together with the data position information indicating that fact.

In this case, the data center determines a road section or road link in which the frequency of interruption of automatic driving within a predetermined period of time is equal to or higher than a predetermined threshold value as a shortage road unit based on probe data from a plurality of vehicles A. The predetermined period of time can be, for example, about 1 to 2 weeks. Here, it is possible that one of the causes of the interruption or failure of the automatic driving control of the vehicle A is that there was some defect in the basic map data of the road section or road link. Therefore, the road section or road link where the automatic driving is interrupted is set as a shortage road unit. As a result, probe data in a road section or road link can be collected at an early stage, and map data can be quickly and accurately obtained. By setting the above-mentioned predetermined period of time to one week or more, it is possible to prevent erroneous determination in the case where the automatic driving is interrupted due to a temporary factor such as a transient heavy rain or a falling object.

In addition, the data center can make the service vehicle run unmanned on the shortage road unit by transmitting a probe instruction signal for traveling the shortage road unit to the service vehicle that is not in use. The service vehicle that is not used includes a service vehicle that has not been reserved for use by the user, a service vehicle that is not in business hours, and the like. A service vehicle includes a vehicle equipped with an automatic driving function and used for MaaS (MobilityasaService) such as unmanned taxis or unmanned fixed-route buses. In addition, a service vehicle includes a rental car or shared car equipped with an automatic driving function of automatic driving level 3 or higher specified by SAE (Automotive Engineers Association). If an unmanned vehicle is configured to autonomously drive a shortage road unit and collect probe data, it is possible to reduce the personnel cost required for map generation/update.

For each shortage road unit determined to have insufficient number of probe data, the response may be changed according to the degree of influence of the shortage road unit, in other words, the importance of updating the map data. For example, for a shortage road unit with a large degree of influence, that is, a high importance, it is possible to actively request driving, transmit a probe instruction signal, and increase the value of the incentive to be given. For a shortage road unit that is less influential, that is, less important, the probe data may be collected only naturally or the value of the incentives given may be reduced.

In this case, the degree of influence of the shortage road unit can be distinguished according to, for example, the road type. For example, the degree of influence can be large on expressways and general national highways, and the degree of influence can be small on narrow streets such as municipal roads. Depending on the number of landmarks or the density of landmarks on the shortage road unit, the degree of influence can be set. According to this, in a shortage road unit with a large degree of influence, the frequency in collecting probe data and thus updating map data can be increased. In a shortage road unit where the degree of influence is small, the frequency in collecting probe data and thus updating the map data can be suppressed. As a result, data processing such as updating map data can be performed more efficiently.

In addition, various changes can be made to the hardware configuration, software configuration, etc. in an in-vehicle apparatus, a vehicle, and a data center. Although the disclosure has been described in accordance with the embodiments, it is understood that the present disclosure is not limited to such embodiment or structures. The present disclosure incorporates various modifications and variations within the scope of equivalents. In addition, various combinations and configurations, as well as other combinations and configurations that include only one element, more, or less, are within the scope and spirit of the present disclosure.

As described above, the input device 4, the recording device 5, the route guidance device 8, and the travel control device 9 may be included in a controller included in the computer in the in-vehicle apparatus 3. Further, the probe data integration device 14, the difference comparison device 15, and the map data update device 16 may be included in a controller included in the sever computer in the data center 2. Further, the input device 4, the recording device 5, the route guidance device 8, the travel control device 9, and the shortage road unit presentation device 24 may be included in a controller included in the computer in the in-vehicle apparatus 23. Yet Further, the probe data integration device 14, the difference comparison device 15, the map data update device 16, and the integrated map verification device 25 may be included in a controller included in the sever computer in the data center 22. Those controllers and methods thereof described in the present disclosure in the above embodiments may be implemented by one or more than one special-purpose computer. Such a computer may be created (i) by configuring (a) a memory and a processor programmed to execute one or more particular functions embodied in computer programs, or (ii) by configuring (b) a processor provided by one or more special purpose hardware logic circuits, or (iii) by configuring a combination of (a) a memory and a processor programmed to execute one or more particular functions embodied in computer programs and (b) a processor provided by one or more special purpose hardware logic circuits. The computer program may be stored, as an instruction executed by a computer, in a computer-readable non-transitory tangible storage medium.

For reference to further explain features of the present disclosure, the description is added as follows.

For example, as a technology for generating a digital road map used for a car navigation apparatus or automatic driving control, a system that generates/updates a map data based on probe data collected from a plurality of probe cars can be considered. In this system, a plurality of vehicles, which are probe cars, are communicably connected to the center, and the center collects, as probe data, vehicle traveling position data obtained over time from GPS as each vehicle travels. Then, the center reproduces the traveling locus of each road from the probe data and updates the map data based on the difference detected from the basic map data in the database.

In the above system, the probe car that transmits probe data will be expanded not only to dedicated vehicles but also to general vehicles. As a result, a large amount of probe data can be collected from all over the country, which makes it possible to obtain highly accurate map data over a wide range. In this case, the center collects the required number of probe data, for example, 10 probe data for each road section or road link. Based on this, it is possible to integrate the probe data and update the map data based on the detection of the difference between the integrated data and the basic map data.

Depending on the type of road, some roads have a large number of traffic and some roads have a small number of traffic. For road sections or road links where probe cars travel infrequently, it is difficult to collect probe data. Thus, it takes time to collect the required number of probe data, and it takes time to update to the latest map data. In this way, for roads with a small number of traffic, the map data is partially inferior in freshness. From the viewpoint of obtaining highly accurate map data over a wide area, it is inferior in coverage, and there is room for improvement.

It is thus desired for the present disclosure to provide a map data generation system, a data center, and an in-vehicle apparatus which generate and update map data based on probe data collected from a plurality of vehicles, and which are capable of promoting collecting the probe data even for road sections or road links that are traveled relatively infrequently.

An aspect of the present disclosure described herein is set forth in the following clauses.

According to an aspect of the present disclosure, a map data generation system is provided to include: in-vehicle apparatuses respectively provided in vehicles; and a data center communicably connected with the in-vehicle apparatuses. The data center collects probe data recording traveling statuses of the vehicles from the in-vehicle apparatuses for performing a road map data generating and updating process of generating and updating a road map data based on the collected probe data. The data center includes a data shortage determination device and a notification device. The data shortage determination device is configured to determine a shortage road unit that is one of data management units corresponding to road sections, road links, or meshes into which a map is divided. The shortage road unit has a shortage in a required number of probe data to perform the road map data generating and updating process. The notification device is configured to issue a notification indicating the shortage road unit determined by the data shortage determination device to the in-vehicle apparatuses. The in-vehicle apparatus includes a guidance device configured to provide a guidance for the vehicle to travel on the shortage road unit in response to receiving the notification from the data center. According to the aspect, in the data center, probe data recording the traveling statuses of a plurality of vehicles are collected by communication with the in-vehicle apparatuses in the plurality of vehicles. When the required number of probe data is collected for each of data management units corresponding to road sections or road links or meshes into which a map is divided, a road map data generating and updating process is performed based on the collected probe data. In this case, in the data center, the data shortage determination device determines, as a shortage road unit, the data management unit in which the number of probe data required for generating/updating the road map data is insufficient. Then, when the data shortage determination device determines that the number of probe data is insufficient, the notification device notifies the in-vehicle apparatuses of the shortage road unit.

Then, in the in-vehicle apparatus, when the notification is received from the notification device, it is recommended that the host vehicle travels on the shortage road unit by the guidance device. As a result, even on roads where the number of vehicles passing by tends to be low, the running of vehicles and the generation of probe data are promoted. As a result, probe data will be collected on a wide range of roads, and the coverage will be improved. As a result, the map data is generated and updated based on the probe data collected from multiple vehicles. In addition, it is possible to promote the collection of probe data even for road sections or road links that are travelled relatively infrequently.

What is claimed is:

1. A map data generation system comprising:
in-vehicle apparatuses respectively provided in vehicles; and
a data center communicably connected with the in-vehicle apparatuses to collect probe data recording traveling statuses of the vehicles from the in-vehicle apparatuses for performing a road map data generating and updating process of generating and updating a road map data based on the collected probe data,
wherein the data center comprises:
a data shortage determination device configured to determine a shortage road unit that is one of data management units corresponding to road sections, road links, or meshes into which a map is divided, the shortage road unit having a shortage in a required number due to the collected probe data having not reached the required number even when a predetermined period of time elapses since the road map data generating and updating process was previously performed, the required number of probe data being set depending on a road type of each of the data management units; and
a notification device configured to issue a notification indicating the shortage road unit determined by the data shortage determination device to the in-vehicle apparatuses,
wherein the in-vehicle apparatus comprises:
a guidance device configured to provide a guidance for the vehicle to travel on the shortage road unit in response to receiving the notification indicating the shortage road unit from the data center.

2. The map data generation system according to claim 1, wherein:
the in-vehicle apparatus comprises a navigation device configured to obtain a recommend route to a destination to execute the guidance along the recommended route; and
the guidance device is further configured to cause the navigation device to obtain a detour route to the destination via the shortage road unit, and to execute the guidance along the detour route to the destination via the shortage road unit.

3. The map data generation system according to claim 2, wherein:
the guidance device is further configured to cause the navigation device to execute the guidance along the detour route to the destination via the shortage road unit in response to determining that executing the guidance along the detour route by replacing the recommended route provides an acceptably small influence on a time of an arrival at the destination.

4. The map data generation system according to claim 1, wherein:
in response to the shortage road unit being located within a predetermined distance range from a current traveling position of the vehicle, the guidance device is further configured to propose to pass through the shortage road unit, to a user.

5. The map data generation system according to claim 1, wherein:
a system administrator gives an incentive to a user of the vehicle traveling on the shortage road unit by following the guidance provided by the guidance device.

6. The map data generation system according to claim 5, wherein:
the guidance device is further configured to present information on the shortage road unit together with information on the incentive given when the vehicle travels on the shortage road unit.

7. The map data generation system according to claim 1, wherein:
the data shortage determination device is further configured to preferentially determine a data management unit existing in an area where a disaster has occurred as the shortage road unit having the shortage in the required number of probe data.

8. The map data generation system according to claim 1, wherein:
the data shortage determination device is further configured to preferentially determine a data management unit in which an interruption in an automatic driving control has occurred as the shortage road unit having the shortage in the required number of probe data.

9. The map data generation system according to claim 1, wherein:
the data center comprises a map verification device configured to verify whether the road map data generated and updated based on the probe data is consistent with an actual road; and
the data shortage determination device is further configured to preferentially determine a data management unit that is determined by the verification device to have a deviation degree from the actual road to be equal to or greater than a predetermined threshold value as the shortage road unit having the shortage in the required number of probe data.

10. A data center to collect probe data recording traveling statuses of vehicles from in-vehicle apparatuses respectively provided in the vehicles to perform a road map data generating and updating process of generating and updating a road map data based on the probe data,
the data center comprising:
a data shortage determination device configured to determine a shortage road unit that is one of data management units corresponding to road sections, road links, or meshes into which a map is divided, the shortage road unit having a shortage in a required number due to the collected probe data having not reached the required number even when a predetermined period of time elapses since the road map data generating and updating process was previously performed, the required number of probe data being set depending on a road type of each of the data management units; and
a notification device configured to issue a notification indicating the shortage road unit determined by the data shortage determination device to the in-vehicle apparatuses.

11. The data center according to claim 10, wherein:
the notification device is further configured to transmit a signal that instructs the in-vehicle apparatus to cause the vehicle to travel on the shortage road unit.

12. An in-vehicle apparatus provided in a vehicle, the in-vehicle apparatus comprising:
a communication device configured
to transmit probe data recording a traveling status of the vehicle to a data center and
to receive, from the data center, (i) a latest road map data and (ii) a notification indicating a shortage road unit that is one of data management units corresponding to road sections, road links, or meshes into which a map is divided, the shortage road unit being determined to have a shortage in a required number due to the collected probe data having not reached the required number even when a predetermined period of time elapses since a road map data generating and updating process was previously performed, the required number of probe data being set depending on a road type of each of the data management units; and
a guidance device configured to provide a guidance for the vehicle to travel on the shortage road unit in response to receiving the notification indicating the shortage road unit from the data center.

13. The in-vehicle apparatus according to claim 12, wherein:
the vehicle includes an in-vehicle actuator for an autonomous driving; and
the guidance device is further configured
to generate a route for the vehicle to travel on the shortage road unit and
to output a control signal to the in-vehicle actuator for the vehicle to perform the autonomous driving.

14. The map data generation system according to claim 1,
wherein the data center further comprises:
a transceiver configured to serve as the notification device to issue the notification to the in-vehicle apparatuses; and
one or more processors communicably connected to the transceiver, the one or more processors being configure to implement the data shortage determination device to determine,
wherein the in-vehicle apparatus further comprises:
a wireless transceiver configured to receive the notification from the data center; and
one or more processors communicably connected to the wireless transceiver, the one or more processors being configure to implement the guidance device to provide the guidance for the vehicle to travel on the shortage road unit.

15. The data center according to claim 10, further comprising:
a transceiver configured to serve as the notification device to issue the notification to the in-vehicle apparatuses; and
one or more processors communicably connected to the transceiver, the one or more processors being configure to implement the data shortage determination device to determine.

16. The in-vehicle apparatus according to claim 12, further comprising:
a wireless transceiver configured to serve as the communication device; and
one or more processors communicably connected to the wireless transceiver, the one or more processors being configure to implement the guidance device to provide the guidance for the vehicle to travel on the shortage road unit.
